(19) United States
(12) Patent Application Publication
(10) Pub. No.: US 2004/0202724 A1
(43) Pub. Date: Oct. 14, 2004

(54) Granules for biocide use

(76) Inventors: Lars Tomasgaard, Drobak (NO); Unni Olsbye, Oslo (NO)

Correspondence Address: YOUNG & THOMPSON, 745 SOUTH 23RD STREET 2ND FLOOR, ARLINGTON, VA, 22202

(21) Appl. No.: 10/481,622

(22) PCT Filed: Jun. 19, 2002
(86) PCT No.: PCT/NO02/00217

(30) Foreign Application Priority Data
Jun. 21, 2001 (NO) 20013097

(51) Int. Cl. A01N 59/20; A01N 25/12

(52) U.S. Cl. 424/635; 504/367

(57) ABSTRACT

The invention relates to biocide active materials which are characterized by the external surface of the material being reduced by granulation followed by thermal treatment, a process of preparing the materials and the use thereof. Active material of biocides is fabricated by granulation followed by thermal treatment. The product is characterized by a narrow particle size distribution and an active surface which can be adapted to a desired colour intensity and leaching rate.

### FIELD OF INVENTION

The present invention relates to a Cu-containing material for biocide applications, a process of preparing such a material, and the use of the material as a biocide.

### BACKGROUND OF THE INVENTION

A purpose of biocides is to prevent the deposition of organic material on different constructions, and is often mixed in a suspension (paint) which is applied to the constructions. The mode of operation comprises slow solution of the biocide active compound in water, and it is absorbed from this by simple organisms being present on or is close to the surface resulting in an intoxication.

Copper was among the first metals which was used in fouling preventive agents for marine applications in a large scale. In the ancient Egypt wooden boats were covered by copper plates to prevent fouling, and the British marine took the same method officially into use in 1762. By the change to steel ships in the nineteenth century it was observed that the copper plates experienced corrosion problems, and they were then replaced by copper-containing antifouling. Copper powder, copper-brass powder, cupric hydroxide, cuprous oxide, cuprous thiocyanate and copper arsenitte have all been used in antifouling to a varying extent. It is now generally accepted that cuprous oxide provides for the best combination of efficiency, economy and ecological acceptability (H. Wayne Richardson (Ed.): “Handbook of Copper Compounds and Applications”, Marcel Dekker, New York, 1997 (4322 p)).

In the work discussed herein attention is paid to the advantages of cuprous oxide in the invention disclosed. The invention as described is still not restricted to cuprous oxide, but is applicable to all kinds of biocide active compounds.

Cuprous oxide can be prepared by electrolysis, pyro-metallurgic og hydro-metallurgic (H. Wayne Richardson (Ed.): “Handbook of Copper Compounds and Applications”, Marcel Dekker, New York, 1997 (432p)):

Method 1: Copper is heated in air to temperatures above 1030° C., wherein cuprous oxide is thermodynamically stable. A cooling must take place in an inert atmosphere to prevent over-oxidation into cupric oxide. The method results in large lumps of copper oxide.

Method 2: Copper is oxidised in an autoclave at 120° C. and 6 atmospheres in the presence of water, air and small amounts of HCl and H₂SO₄. The method results in a variable size of particles and density, depending on the pressure and temperature of the reactor.

Method 3: Copper oxide is precipitated by mixing a dissolved copper salt (f.i. Cu₂(NH₃)₄CO₃ or CuCl) with NaOH in an aqueous solution. The method results in variable particle sizes depending on pH and the temperature of the mixing step.

The efficiency of bioactive compounds depends on several factors: A specific copper compound, the dissolution rate of the copper compounds and the persistence of the solution. For environmental reasons it is often desirable achieving a slow dissolution of the copper compound. This may among others be obtained by increasing the circumference of the elemental particles, i.e. by reducing their total external surface. A reduction of the external surface has also another desirable effect: The particles will be colourless and can be used in paint of different colours.

A conventional copper oxide has elemental particles of a diameter in the range <5 micron. In the last years a new commercial product has entered the market having a diameter in the range >10 micron under the name: XLT (extra Low Tint). This product may be produced either through the powderisation of copper oxide prepared by high temperature oxidation or by thermal treatment (sintering) of small elemental particles. Both processes involve the use of temperatures in excess of 1000° C., which implies heavy demands as to the process equipment and materials. Further, both processes result in a variation of particle size and large, respectively small, particles have to be powderised, respectively sintered repeatedly after the first cycle to achieve a satisfying yield of the process.

The aim of the present invention was therefore to provide a product and a process which was not affected by the above disadvantages.

### SUMMARY OF THE INVENTION

This is achieved according to the instant invention by those features which appear from the characterizing clause of claim 1.

Particularly preferably the thermal treatment is performed in the range of 600-950° C. It is further preferable that one or more binding agents are added prior to the granulation.

Particularly preferred an organic compound is used, preferably polyvinyl alcohol (PVA) is used as the binding agent.

Preferably the material substantially comprises Cu₂O.

It is further preferred that the material includes one or several inorganic compound(s) having a melting point in the range 150-800° C.

Further, it is preferred that the inorganic compounds include cations belonging to the group 1b, 2a, 6b, 7b and/or 8.

In addition it is preferred that the material also includes some bivalent Cu, preferably in the form of CuO.

Further the invention provides for a process of preparing a Cu₂O having a low strength of colour as defined above, wherein conventionally prepared Cu₂O is added to one or several binding agents, granulated and then subjected to a thermal treatment.

Preferably the granulation takes place in a spray drier, particularly having rotating nozzles. An organic compound is preferably used as the binding agent, particularly preferred polyvinyl alcohol (PVA).

The thermal treatment is preferable effected in the temperature range of 400-1000° C., particularly preferred in the temperature range of 600-950° C.

Finally the invention relates to the use of the material as defined above as a biocide.

Particularly it is used for the inhibition of fouling.

The main aim of the invention as disclosed herein was to prepare large particles of copper oxide at lower temperatures than the conventional processes. Further it was an object to enable the preparation of particles having a well defined size and also a well defined external surface. These aims were achieved according to the invention by using a process wherein small elemental particles are granulated to the desired particle size and then subjected to a thermal treatment at 400-1000° C. until they have obtained the desired external surface. Further, it was found that the product which is prepared according to the invention disclosed has a further advantage in the sintered particles including cavities. This will facilitate the floating in a suspension compared to conventional XLT.

The granulation of the biocide active material implies the addition of a binding agent. If the binding agent is organic and the subsequent thermal treatment is effected in a reducing or inert atmosphere, a degradation of the binding agent may result in a partial reduction of the granulated material. Such a reduction can be counteracted by an appropriate amount of an inorganic material at a higher level of oxidation, such as CuO being present during the process. This material may be an integral part of the biocide active material, or it can be added prior to the granulation. As an alternative to an organic binding agent an inorganic binding agent having a lower melting point than the bioactive material may be used, which is reacted with the surface of the bioactive material prior to the granulation.

### DESCRIPTION OF FIGURES

FIG. 1 shows the particle sizes of granulated, thermally treated copper oxide prepared in Example 3 described in the following.

The invention is illustrated by, but not limited, the examples to follow:

### EXAMPLES

General: The granulation tests were performed in a conventional spray drier having rotating nozzles (APV). The sintering tests were performed in a tube furnace by continuous feed of N₂ gas. The temperature gradient was 5° C./min. during the heating and about 2° C./min. during the cooling. Particle size measurements were performed either by sedimentation in liquid (Micromeritics SediGraph 5100) or laser-scattering above a dry product (Malvern Scirocco 2000). Parallel measurements on the two apparatures indicated that they gave the same average particle size (in the following designed: “d(50)”). Colour analyses of coatings were performed by means of a Minolta CM-3500d spectrophotometer. The specific surface area of the products was measured by means of a one-point BET.

In the following “PG” is a term used for single particles having an average particle size of about 3 micron, whereas “Agro” is a term which is used for single particles having an average particle size of about 1.5 micron.

### Example 1

### Comparative Example

Conventional cuprous oxide (prepared by Method 2 above) was subjected to thermal treatment at 743° C., 839° C. and 933° C., respectively. The average particle size prior and subsequent to the thermal treatment is indicated in Table 1. Table 1 indicates that the particle size increases with increasing thermal treatment temperature. Table 1 further indicates that increased permanence of the thermal treatment at 743° C. (4 hours against 2 hours) does not further increase the particle size.

When preparing XLT it is desirable to avoid fractions with are less than 5 μm. For conventional cuprous oxide this was obtained only for the sample which was subjected to thermal treatment at 933° C. This result indicates that conventional cuprous oxide has to be subjected to thermal treatment at a higher temperature to comply with the requirement of XLT production.

### Example 2

### Granulation of Cu₂O with Binding Agent

To wet cuprous oxide polyvinyl alcohol was added (Mowiol 4-88, 0.2-0.5 percent by weight) and granulated in a spray drier having a rotating atomizer. The water contents of the composition was in the range of 25-30 percent by weight. The particle sizes measured prior and subsequent to granulation are shown in Table 2. It was observed that an increased content of PVA and increased water content both result in a lower particle size. This is a consequence of the changes reducing the viscosity of the composition and implies the possibility of a higher velocity of the rotating atomizer.

### Example 3

### Sintering of Granulated PG

Three of the samples from Example 2 were subjected to thermal treatment in the temperature range 743-933° C. The particle size of the materials prior and subsequent to the thermal treatment is shown in Table 3.

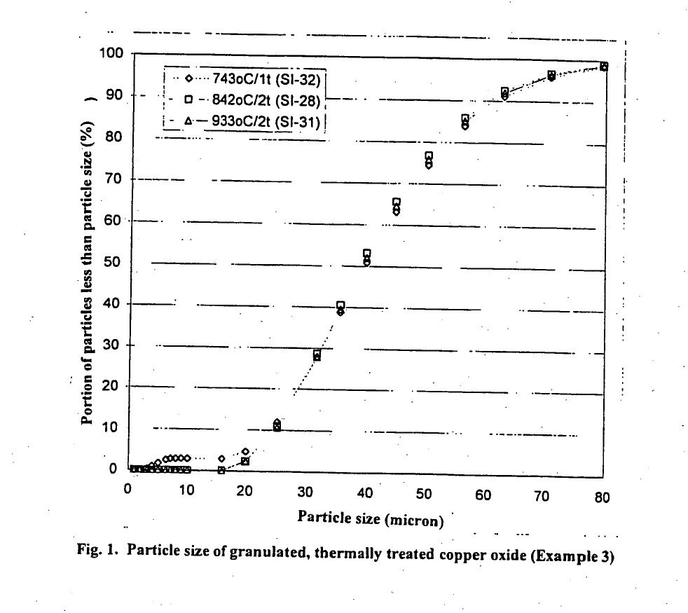

Table 3 shows that the particles to a great extent retained their original granulated particle size after the thermal treatment. At the lowest temperatures a “tail” of particle sizes in the range <10 microns were observed, whereas this tail had disappeared at higher temperatures. This is shown for granulated sintered Agro in FIG. 1. At the same time it was visually observed that the particles got a more intensive lilac colour at increasing sintering temperature.

### Example 4

### Rubbing Stability and Colour Intensity

The rubbing stability and colour intensity of a thermally treated article was tested at a coating:

Cuprous copper oxide (1 g) is mixed with TiO₂ (1 g) and added a mixture of Phliolite resin (Goodyear) (0.8 g) and White Spirit (0.4 g). The mixture is turned and rubbed with a spatula until all loose agglomerates are disintegrated. The dissolving of agglomerates can be visually followed by the coating developing a reddish gleam. The final composition is then applied across a smooth paper board to obtain a completely covering layer of paint and dried. The colour intensity of the dried coating is investigated by means of spectrophotometer.

PG granulated and thermally treated at 743° C. (SI-02) gave a reddish colour at great mechanical stress, whereas PG granulated and thermally treated at 839° C. (SI-08) gave a stable, bright colour. This result indicates that the PG granulates are completely sintered together subsequent to a thermal treatment at 839° C., but not at 743° C.

Agro granulated and thermally treated at 743° C. (SI-27) gave a stable bright colour at great mechanical stress. This result indicates that a smaller size of the elemental particles results in sintering at lower temperature. This result was expected from energetic considerations. It is expected that a still finer splitting of the particles prior to granulation will result in sufficient sintering at still lower temperatures.

Colour parameters for coatings of samples from Example 1 and 3 are presented in Table 4. Table 4 indicates that the granulated samples are faint in colour after sintering compared with non-granulated sintered samples and with a commercial sample.

### Example 5

### Specific Surface of the Materials

The specific surface of conventional, granulated and granulated/sintered cuprous oxide is presented in Table 5. Table 5 indicates that the total external surface of the particles is considerably reduced by an increase of the sintering temperature from 743 to 933° C. It further indicates that the same external surface is achieved by sintering of the largest unit particles at 839° C. (SI-14), like subsequent to sintering of the smallest unit particles at 743° C. (SI-27). This result is consistent with the results from measurements of the rubbing stability and colour intensity (Example 4). Table 5 further indicates that the specific surface is not changed subsequent to granulation by the addition of a binding agent.

### Example 6

### Stability

Granulated, sintered copper oxide (SI-09) was stabilized with 0.5 percent glycerine and tested for stability by storage in water saturated air (54° C. 72 hours). The results of the tests are presented in Table 6. The product shows good stability during the test.

### Example 7

### Characteristics of the Products

The contents of cuprous oxide and metallic copper was compared for particles prepared according to the invention as described herein and for particles prepared by the conventional sintering of copper oxide. The results are presented in Table 7. The results indicate that this invention results in a low content of metallic copper, even with the addition of an organic binding agent.

TABLE 1
Particle size of conventional copper oxide sintered at
743-933° C. in N₂-atmosphere.

| | | Sintering | | Particle |
|---|---|---|---|---|
| | | temperature | Permanence of | size |
| Lot number | Mother batch | (° C.) | the sintering (h) | d(59) (m) |
| PG-231000 | PG-231000 | Unsintered | 0 | 3 |
| SI-03 | ″ | 743 | 2 | 6 |
| SI-04 | ″ | 743 | 4 | 6 |
| SI-05 | ″ | 743 | 4 | 6 |
| SI-06 | ″ | 839 | 2 | 8 |
| SI-01 | ″ | 933 | 2 | 12 |

TABLE 2
Particle size of conventional copper oxide granulated in a
spray dryer

| Lot number | Mother batch | Particle size d(59) (m) |
|---|---|---|
| PG non-granulated | PG-nn-nn.nn | 3 |
| XLT-G K1 | ″ | 37 |
| XLT-G K2 | ″ | 34 |
| XLT-G K3 | ″ | 26 |
| Agro non-granulated | Agro-300301 | 1.5 |
| F-6581-1 | ″ | 59 |
| F-6581-2 | ″ | 46 |
| F-6581-3 | ″ | 38 |

TABLE 3
Particle size of granulated copper oxide sintered at 743-933° C.
in N₂-atmosphere.

| | | | Permanence | |
|---|---|---|---|---|
| | | Sintering | of the | Particle size |
| Lot number | Mother batch | temp. (° C.) | sintering (h) | d(59) (μm) |
| XLT-G K1 | XLT-G K1 | Non-sintered | 0 | 37 |
| SI-02 | ″ | 743 | 2 | 9 |
| SI-08 | ″ | 839 | 2 | 34 |
| XLt-G K3 | XLT-G K3 | Non-sintered | 0 | 26 |
| SI-12 | ″ | 839 | 2 | 20 |
| SI-24 | ″ | 933 | 2 | 26 |
| F-6581-2 | F-6581-2 | Non-sintered | 0 | 46 |
| SI-32 | ″ | 743 | 1 | 40 |
| SI-27 | ″ | 743 | 2 | 36 |
| SI-28 | ″ | 839 | 2 | 39 |
| SI-31 | ″ | 933 | 2 | 39 |

TABLE 4
Colour Analysis of a coating of sintered Cu₂O

| Lot Number | Description | L | A | B | dE |
|---|---|---|---|---|---|
| Standard | White plate | 998.9 | −0.2 | −0.3 | 6.5 |
| X | Commerical sample from | 81.3 | 0.2 | −1.8 | 17.7 |
| | competitor | | | | |
| SI-06 | PG sintered 839° C. | 78.3 | 0.8 | −4.6 | 21.2 |
| SI-01 | PG sintered 933° C. | 84.2 | 0.6 | −2.4 | 14.9 |
| SI-14 | Granulated PG (XLT-G) | 92.5 | −0.7 | −0.1 | 6.5 |
| | sintered 839° C. | | | | |
| SI-27 | Granulated Agro (F-6581-2) | 87.3 | −1.0 | −2.1 | 11.8 |
| | sintered 743° C. | | | | |
| SI-28 | Granulated Agro (F-6581-2) | 92.5 | −1.3 | 0.6 | 6.5 |
| | sintered 839° C. | | | | |
| SI-31 | Granulated Agro (F-6581-2) | 91.7 | −1.4 | −0.6 | 7.3 |
| | sintered 933° C. | | | | |

TABLE 5
Specific surface of cuprous oxide

| | | | | Specific |
|---|---|---|---|---|
| | | Sintering | Duration of | surface |
| Lot number | Mother batch | temperature(° C.) | sintering (h) | (m²/g) |
| Agro 300301 | Agro 300301 | Non-sintered | 0 | 1.9 |
| F-6581-2 | F-6581-2 (Agro | Non-sintered, | 0 | 2.0 |
| | 3003019 | granulated | | |
| SI-27 | ″ | 743 | 2 | 0.44 |
| SI-28 | ″ | 839 | 2 | 0.28 |
| SI-31 | ″ | 933 | 2 | 0.10 |
| SI-14 | XLT-G | 839 | 2 | 0.43 |

TABLE 6
Stability test of granulated, sintered cuprous oxide (SI-09)
(Example 6).
Test conditions: Water-saturated air, 54° C., 72 hours.

| Properties | Prior to storage | After storage |
|---|---|---|
| Total Cu (%) | 88.6 | 88.2 |
| Reduction power (%) | 99.7 | 99.4 |
| Metallic Cu (%) | 0.14 | 0.12 |

TABLE 7
Characteristics of sintered samples of cuprous oxide.

| | | Total | |
|---|---|---|---|
| Sample | Description | Cu (%) | Metallic Cu (%) |
| SI-09 | PG granulated and sintered 839° C. | 88.6 | 0.1 |
| SI-06 | PG sintered 839° C. | 88.2 | 0.6 |
| SI-01 | PG sintered 933° C. | 88.8 | (not measured) |

Conclusions

The above examples indicate that the invention as described herein is suitable to prepare copper oxide particles having a low colour intensity subsequent to treatment at lower temperatures than for conventional thermal treatment of element particles. Further, the examples indicate that the particle size distribution is narrow and can be adapted by the proper selection of granulating conditions. The total external surface of the granulate which is decisive for the leaching velocity can partly be adapted by the proper selection of thermal treatment temperature. Further, the examples indicate that the particles being prepared by the method of this invention possess a good stability and a low content of metallic copper.

1. A biocide Cu-containing material in the form of granulates having a reduced external surface, characterized in being prepared by granulation followed by thermal treatment at temperatures in the range 400-1000° C.

2. The material according to claim 1, wherein the thermal treatment is effected in the range 600-950° C.

3. The material according to claim 1, wherein one or more binding agent(s) are added prior to the granulation.

4. The material according to claim 1, wherein an organic compounds, preferably polyvinyl alcohol (PVA) is used as a binding agent.

5. The material according to claim 1, wherein the material mainly comprises Cu₂O.

6. The material of claim 5, wherein the material further includes one or more inorganic compound(s) having a melting point in the range of 150-800° C.

7. The material of claim 6, wherein the organic compounds includes cations belonging to the group 1b, 2a, 6b, 7b and/or 8.

8. The material of claim 1, wherein the material further includes some divalent Cu, preferably in the form of CuO.

9. A process of preparing a faint-coloured Cu₂O according to claim 1, wherein conventionally prepared Cu₂O is added one or more binding agent(s), granulated and then thermally treated at temperatures in the area of 400-1000° C.

10. The process of claim 9, wherein the granulation is effected in a spray dryer, preferably having rotating nozzles.

11. The process of claim 9, wherein an organic compound, preferably polyvinyl alcohol (PVA) is used as a binding agent.

12. The process of claim 10, wherein the thermal treatment is effected in the temperature range of 600-950° C.

13. The use of a material of claim 1 as a biocide.

14. The use of claim 13 for the inhibition of fouling.
